(19) United States
(12) Patent Application Publication
(10) Pub. No.: US 2009/0277023 A1
(43) Pub. Date: Nov. 12, 2009

(54) Constructive arrangement applied to a thimble for use in pre-op shaving

(76) Inventor: Rodrigo Dos Santos Coelho, Porto Alegre (BR)

Correspondence Address: CLIFFORD H. KRAFT, 320 ROBIN HILL DR., NAPERVILLE, IL, 60540, US

(21) Appl. No.: 12/424,088

(22) Filed: Apr. 15, 2009

(30) Foreign Application Priority Data
May 8, 2008 (BR) MU 8801452-5

(51) Int. Cl. B26B 21/52

(52) U.S. Cl. 30/526

(57) ABSTRACT

A CONSTRUCTIVE ARRANGEMENT APPLIED TO A THIMBLE FOR USE IN A PRE-OPERATIVE SHAVING comprises a two or three-bladed refill cartridge (1) (or any number of blades) attached to a handle (thimble) (2) prolonged or elongated by the four longitudinal rods (3) with lateral flaps for its rotation (4) and has a property of being adapted to the index finger in a process similar to the sewing thimble and clipper, making easier the malleability of the proposed utility model.

This application claims priority from Brazilian application MU 8801452-5 filed May 8, 2008.

### BACKGROUND

1. Field of the Invention

The present invention relates to a constructive arrangement applied to a thimble for use in pre-operative shaving, made of plastic material used for shaving off hair, whose new feature is an anatomic handle which is attached to the distal portion of the index finger making shaving easier. It is similar to a thimble used in sewing practices with a special characteristic that it is used for pre-operative shaving and is anatomical and adjustable to the distal portion of the index finger as it is adjusted by gloving as a thimble or by means of a clipping mechanism through its four longitudinal rods of flexible plastic material. It also has lateral flaps on each rod to allow the user to rotate it with his/her other fingers as needed.

2. Description of the Prior Art

Blade razors, either disposable or not, are used for shaving off hair. There are a lot of substantial differences among them regarding the manner in which their blades cut; there are even differences in the part that comprises the handle of the razor.

On the market, there is a wide variety of razors intended for shaving off hair and, also, so called “devices for pre-operative shaving”. Most of them require considerable hand dexterity to avoid cutting the skin and, as far as they go, a user has to use at least two of his/her fingers (the index finger and any other finger) to hold the razor handle in such a manner that his/her own hand that holds the razor cannot make a movement other than a pincer-like grip of the handle, the rest of the fingers remaining without any use since the thumb will be always necessary to firmly hold the handle.

Nevertheless, there is not any known device which can perform pre-operative shaving in which the hand that operates it can, for instance, rest on both sides, with the thumb and the middle finger over the shaved site without requiring large physical effort, and therefore ensuring safer shaving considering also that the fingers can be used for stretching the skin for closer shaving or even to allow the hand that performs the pre-operative shaving to hold any other small-sized object necessary for pre-operative shaving such as cotton, shaving cream, an astringent (potassium alum, for example) or any other cutting instrument.

### SUMMARY OF THE INVENTION

Due to the considerations pertinent to the state of the art and the objective of this request, the development of a constructive arrangement applied to a thimble for use in pre-operative shaving, which comprises a hair shaving device with two or three parallel blades in the front portion, is proposed. The advantage of this device is that its handle is embodied in such a manner that it can remain attached next to the distal portion of the index finger of the device operator in a process similar to that of a sewing thimble (by gloving) and to that of a clipper enabling the device operator to use the remaining fingers of his/her hand to rest on the shaved site, thus ensuring safer shave and even providing a possibility according to which the hand that operates the device can hold another instrument.

### DESCRIPTION OF THE FIGURES

The invention proposed herein is characterized by means of drawings representative of the constructive arrangement applied to a thimble for use in pre-operative shaving in such a manner that the device can be easily reproduced by the proper technique, allowing the full characterization of the functionality of the object claimed herein.

The descriptive part of the report is based on the developed figures which express the best or preferential manner of embodying the product currently conceived through a detailed and consecutive numeration and clarifies the aspects that may be implied by the adopted embodiment so as to clearly determine the protection claimed herein.

These figures are merely illustrative and do not limit the scope of the present invention. Therefore, the figures are as follows:

FIG. 1—is a perspective view showing the front and lateral portion of the device.

FIG. 2—is a view of the utility model from above.

FIG. 3—is a lateral view of the utility model.

### DESCRIPTION OF THE INVENTION

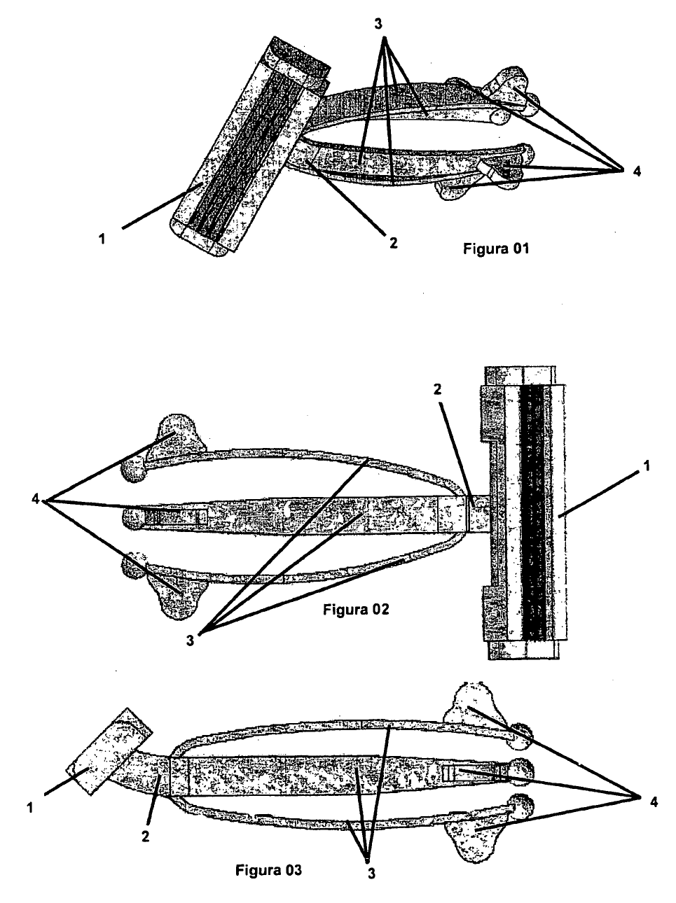

The present invention relates to a constructive arrangement applied to a thimble for use in pre-operative shaving which, as illustrated in FIGS. 1-3, comprises a two-bladed or three-bladed cartridge (or any number of blades) refill in the front portion of the device (1), a fixed handle next to the cartridge refill (2), prolonged or elongated by the four longitudinal rods that are adapted to the distal portion of the index finger (3) and with lateral flaps for its rotation (4).

The thimble can be made of disposable plastic material that provides better flexibility and anatomical application of the device.

A constructive arrangement applied to a thimble for use in pre-operative shaving with its cutting system positioned in the front portion of the device can be fixed or movable in order to follow the shape of the site that is being prepared.

A constructive arrangement applied to a thimble for use in pre-operative shaving can be moved by the propulsion caused by the movement of the index finger.

Several descriptions and illustrations have been presented to aid in understanding the present invention. A person with skill in the art will realize that numerous changes and variations can be made without departing from the spirit of the invention. Each of these changes and variations is within the scope of the present invention.

I claim:

1. A CONSTRUCTIVE ARRANGEMENT APPLIED TO A THIMBLE FOR USE IN PRE-OPERATIVE SHAVING characterized in that it has a handle formed by four longitudinal anatomical rods that can adapt to the index finger of the device operator.

2. THE CONSTRUCTIVE ARRANGEMENT APPLIED TO A THIMBLE FOR USE IN PRE-OPERATIVE SHAVING as claimed in claim 1, enabling a safer shave due to its property that frees other fingers from being used for holding the handle of the device.

3. THE CONSTRUCTIVE ARRANGEMENT APPLIED TO A THIMBLE FOR USE IN PRE-OPERATIVE SHAVING as claimed in claim 1, enabling a hand that operates the device to hold other objects for pre-operative shaving without posing risks or complexity while handling the device.

4. A shaving device comprising:
a handle formed from a plurality of elongated members;
a blade cartridge attached to a proximal end of said handle;
a plurality of lateral flaps attached to a distal end of said handle;
wherein, said handle, blade cartridge and lateral flaps form a shaving system that can fit onto a user's index finger.

5. The shaving device of claim 4 with four elongated members.

6. The shaving device of claim 4 with two lateral flaps.
